(19) United States
(12) Patent Application Publication
(10) Pub. No.: US 2011/0276448 A1
(43) Pub. Date: Nov. 10, 2011

(54) PLUG-IN HYBRID AND ELECTRIC VEHICLE CHARGING SYSTEM

(76) Inventors: Harry LEONARD PERPER, N. Potomac, MD (US); James Randall Beckers, Rockville, MD (US); Mark Meister, Potomac, MD (US)

(21) Appl. No.: 13/101,578

(22) Filed: May 5, 2011

Related U.S. Application Data
(60) Provisional application No. 61/331,591, filed on May 5, 2010.

(51) Int. Cl. G06Q 30/00; B60Q 1/00

(52) U.S. Cl. 705/34; 340/455; 180/65.21

(57) ABSTRACT

An invention is described that enables a vehicle's electrical energy storage devices to charge in parking areas in which components of this invention are installed. The amount of energy consumed, combined with the amount charged are the components of a transaction. An embodiment allows the vehicle owner to have the cost of the energy consumed charged to his home electric bill. Another embodiment allows the vehicle owner to have the cost of the energy consumed charged to his home electric bill by recording his personal identification number at a kiosk or other input device co-locate at the parking area.

### CROSS-REFERENCE TO RELATED APPLICATION(S)

This application is related to and claims priority to U.S. provisional application entitled A Plug-in Hybrid and Electric Vehicle Charging System having Ser. No. 61/331,591, by Perper et al, filed My 5, 2010 and incorporated by reference herein.

### BACKGROUND

1. Field

The embodiments discussed herein are directed to a plug-in hybrid and electric vehicle charging system.

2. Description of the Related Art

The world's vehicle manufacturers have begun to design and build plug-in hybrid and electric vehicles to address the need to reduce the reliance on fossil fuels for energy. One consequence of the transition to these types of vehicles is the need to charge the vehicle electric energy storage devices, batteries in most cases, in a variety of locations. The default recharging location for these vehicles is typically the owner's home or the vehicle's depot. However, workers, for example, may need to charge their vehicles prior to returning to the depot and commuters will want to charge their vehicles while working. The system discussed provides a solution involving an embodiment of a method for charging vehicles and having the cost of the electricity consumed charged to the vehicle owner's home or corporate utility bill. A second embodiment provides a method for charging vehicles in parking areas with vehicle charging stations that allow the vehicle owner to pay for the energy consumed via a pre-defined personal identification code (PIN code) and charged to a central account or home utility bill.

### SUMMARY

It is an aspect of the embodiments discussed herein to provide a system to enable electric or plug-in hybrid vehicles to be re-charged away from their home or other storage area with the cost of the power consumed, charged to the vehicle owners utility bill.

The above aspects can be attained by a system that allows a vehicle, such as a hybrid having a battery, an all electric vehicle, etc. to be charged in locations away from the owner's home and have the cost of the charge billed to the owner's home utility bill.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates a Vehicle Re-charge System Design.

FIG. 2 shows a Vehicle Power and Battery Charger System.

FIG. 3 depicts a Power and Data Interface.

FIG. 4 shows a Local Power Control System.

FIG. 5 illustrates a Central Control System.

FIG. 6 depicts a Local Utility Computer System.

FIG. 7 shows a Home Computer System.

FIG. 8 shows a flow chart of the operation a Central Control System

FIG. 9 depicts embodiment 2.

FIG. 10 shows Data Packet Structures.

FIG. 11 shows Data Tables.

FIG. 12 shows Data Flows

FIG. 13 shows a flow chart of the operation a Vehicle Power and Battery Charger System

FIG. 14 shows a flow chart of the operation a Power and Data Interface

FIG. 15 shows a flow chart of the operation a Local Power Control System

FIG. 16 shows a flow chart of the operation the Local Utility Computer System

### DETAILED DESCRIPTION OF THE EMBODIMENTS

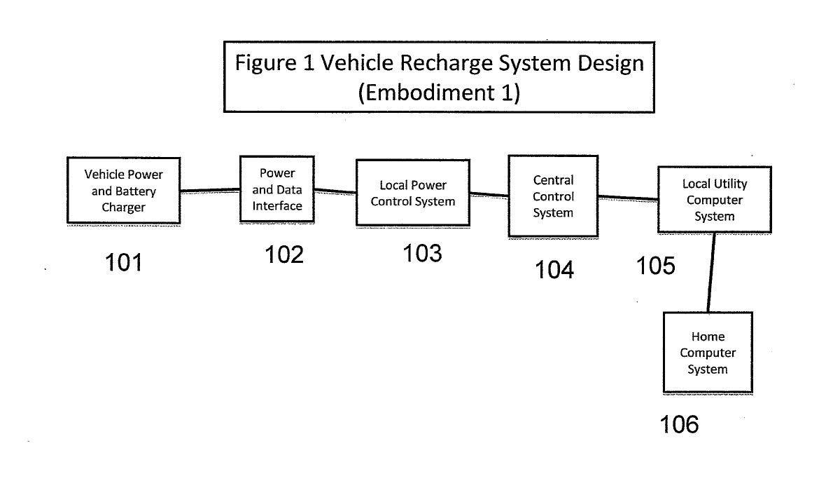

The following embodiment is depicted in various FIGS. 1 through 8 and 10 through 16. This embodiment (FIG. 1) is a system composed of a Vehicle Power and Battery Charger system 101, Power and Data Interface 102, Local Power Control System 103, Central Control System 104, Local Utility Computer System 105 and Home Computer 106.

This embodiment can operate as discussed below.

Operation Overview

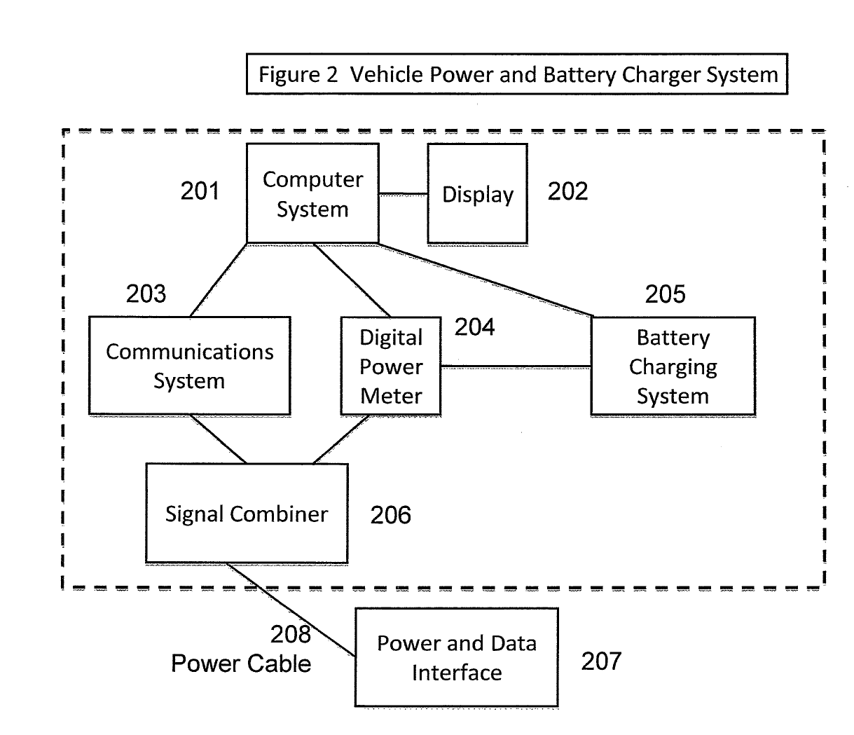

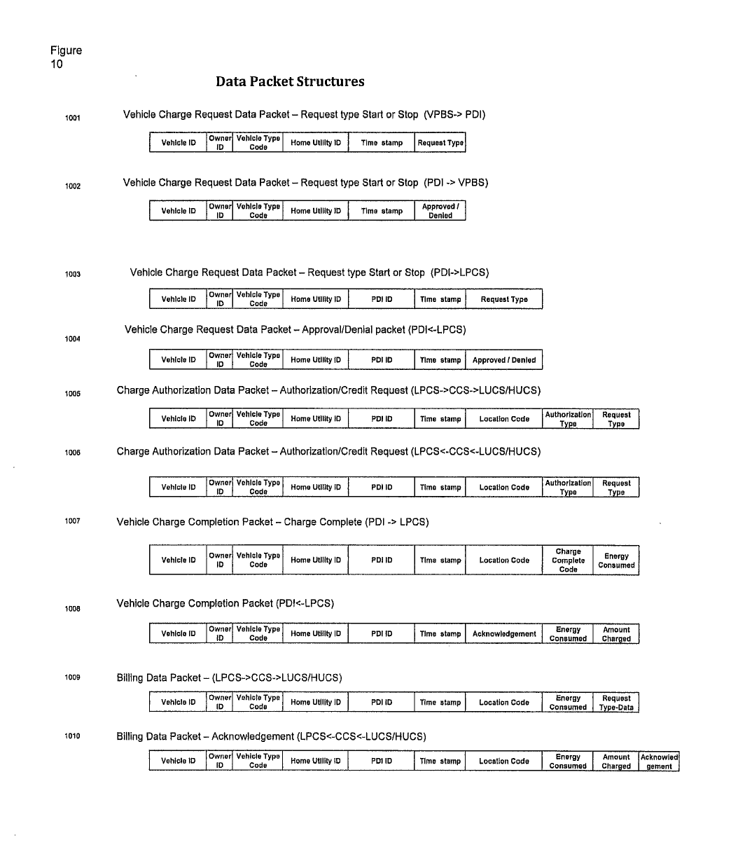

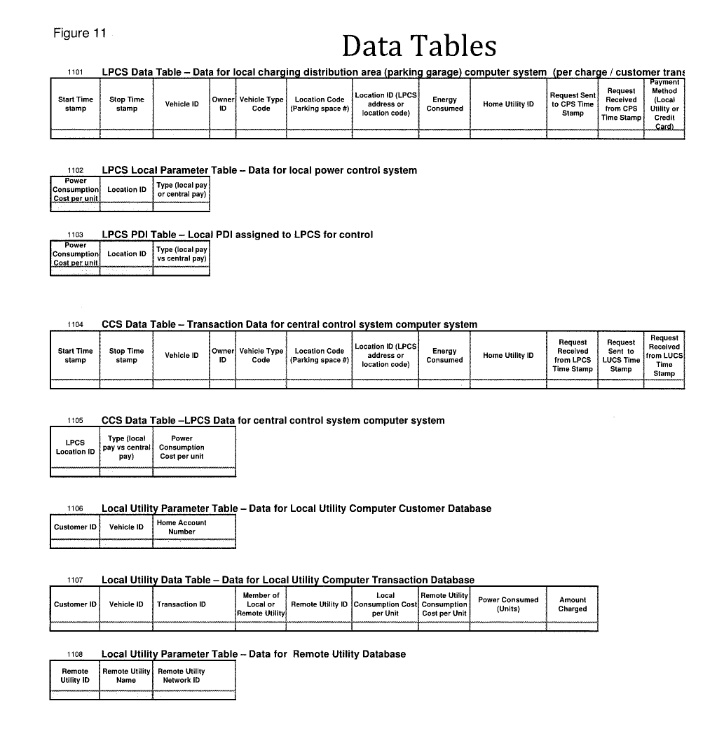

A vehicle operator decides to re-charge the vehicle, which includes an embodiment, in a parking area, such as a public or private parking area, that includes an embodiment. See FIG. 1. The vehicle is parked in a parking spot with an electrical outlet that includes the Power and Data Interface 102 (PDI). The vehicle operator can connect the Vehicle Power and Battery Charging System (VPBCS) 101 to the electrical outlet adjacent to the parking space via a vehicle charging power cable. The power cable and outlet could be of any power standard (120 VAC, 240 VAC, etc.) implementation. Once the power cable is connected between the VPBCS 101 (FIG. 2) and the PDI 102, these two components establish a communication link and exchange vehicle identification information via data packets (FIG. 10). The PDI 102 relays the data packet received to the Local Power Control System (LPCS) 103. The LPCS 103 controls the PDI 102, tracks the power consumed by each vehicle and communicates with a Central Control System (CCS) 104. Communication with the CCS 104 includes account authorization information, power consumption for each transaction, power billing rate, etc. The CCS 104 tracks the transactions occurring at each LPCS 103, communicates with a number of LPCS' 103 and communicates with the Local Power Utility 105. The CCS 104 provides authorization information to the LPCS 103, maintains a database, FIG. 11, of the LPCSs 103, that are associated with itself, maintains a transaction database 1107, FIG. 11, and communicates with the Local Power Utility (Utility) 105. Communication with the local utility can include authorization requests and transaction records. Once the car or other type of vehicle, such as a truck, has been charged or the operator decides to disconnect the power cable a transaction packet is generated by the PDI 102. That transaction is charged to the vehicle owner's power bill and optionally recorded within the VPBCS 101 of the vehicle.

An embodiment operates as discussed below.

1) Vehicle Power and Battery Charger (FIG. 2) is connected to a PDI 207 via a power cable 208. 2) Power Data Interface (PDI) 102 communicates with the vehicle's Vehicle Power and Battery Charger System (VPBCS) 101. The communication can include packets to the PDI 102, 1001, 1002 from the VPBCS 101 which includes the vehicle and owner identification information. This information is used to determine the vehicle's owner authorization status. 3) The PDI 102 communicates with the Local Power Control System (LPCS) 103. The communication can include the PDI 102 sending the vehicle identification number to the LPCS 103 and the LPCS 103 sending the PDI 102 an authorization code to turn on the power for charging the vehicle using packets 1003, 1004. The PDI 102 also communicates the power consumed by the vehicle VPBC 101 to the LPCS 103 when vehicle charge is complete or the power cable 208 is disconnected. 4) The LPCS 103 communicates with the Central Control System (CCS) 104 to obtain authorization for power consumption charging, communicate transaction information, power consumed, vehicle identification, etc. and system software and maintenance information. 5) The CCS 104 communicates with any number of LPCSs 103. The CCS 104 also communicates with the local power utility computer system (Utility) 105. The communication with Utility 105 can include authorization requests and response packets both positive and negative 1005, 1006 and transaction information vehicle identification, power consumed, vehicle location, billing information, etc. 6) Utility 105 responds to authorization requests with a positive or negative response packets 1005, 1006 depending on the vehicle owner's account status. In some cases the Utility 105 will contact other non-local (remote) utilities if the vehicle owner is not a customer of the local utility, such as when the home of the vehicle is located in an area of another power utility. Utility 105 uses the transaction information to determine the billing amount to be added to each vehicle owner's bill at the time the bill is rendered or passes the transaction information to the non-local utility. 7) Once the vehicle charge is complete or the vehicle is disconnected from the PDI 102 a transaction packet 1007, 1008 is generated. The PDI 102 reports the energy consumed to the LPCS 103 via packets 1007, 1008. The LPCS 103 records the energy consumed and the vehicle identification information and reports this information to the CCS 104 via packets 1009, 1010. The CCS 104 records the energy consumed and the vehicle identification information and reports this information to the Utility 105 via packets 1009, 1010. The Utility 105 records the energy consumed and the vehicle identification information and generates a billing item to be added to the utility bill for the vehicle owner. The Utility 105 reports the billing amount to the CCS via the packet 1010. 8) If the vehicle owner is not a customer of the Utility 105 the transaction information is forwarded to the vehicle owner's non-local or remote utility for billing.

Plug-in hybrid and electric vehicles all have integrated power storage re-charging systems. A portion of this embodiment can be integrated into the re-charging system. The Vehicle Power Battery Charger System (VPBCS), 101, communicates with the PDI 102 utilizing packetized data. The VPBCS, FIG. 2, can include a computer system 201, display 202, communication system 203, digital power meter 204, battery charging system 205 and a signal combiner 206. The computer system 201 contains memory that holds the vehicle identification and vehicle owner information in the form of the vehicle identification number (VIN) and the vehicle owner identification code. The computer system 201 communicates with the battery charging system 205 to monitor the battery charge status, the digital power meter 204 to monitor the energy consumed during the battery charging process and the PDI 207 to enable the charging process. The communication system 203 can convert the digital communication signal to/from the computer system 201 to the standard power line signal and protocol for communication with the PDI 207. That is, the communication to/from the vehicle and the PDI 102 can be over the same power cable that provides the charging power. An alternative is to have a separate wire line or optical fiber connection via a multiple connection connector/plug. A further alternative is to provide for secure wireless communication between the vehicle and the PDI and or LPCS. When a power cable communication is used, the signal combiner adds the power line signals passing to and from the PDI 207 to the power cable 208 connecting the vehicle to the PDI 207. The VPBCS FIG. 2 monitors the charge level of the vehicle power storage devices 205 (batteries, typically), monitors the plug connection port, determines the charging level, controls the charge level during charging and communicates with the Power Data Interface 207 to start and end charging. The VPBCS, FIG. 2, provides a human user interface (via a display) 202 within the vehicle to allow the vehicle owner/operator to perform input/output functions. The VPBCS, FIG. 2, initially requires the owner identity code (Owner ID) and home utility identity code. In addition the owner/operator can optionally set a battery charging minimum and maximum percentage of charge.

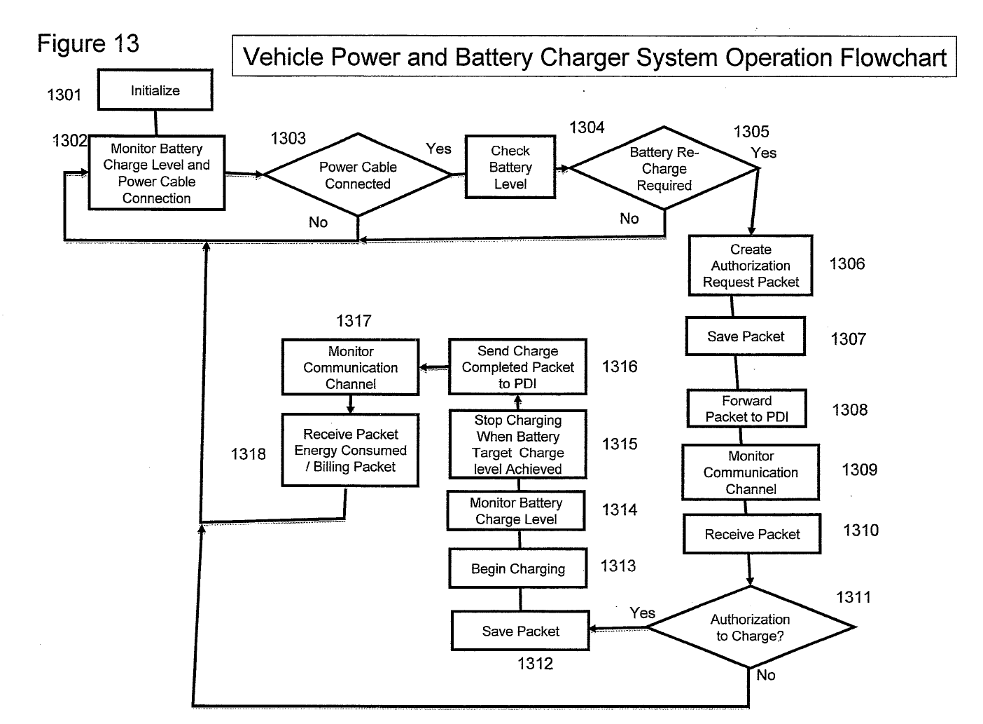

Once the VPBCS, FIG. 2, computer system 201 is initialized it performs the following functions. The computer system 201 continuously monitors the battery 205 charge level. In addition, the computer system 201 monitors the power plug connection port for the connection of a power cable 208. When a power cable 208 is attached the computer system 201 monitors the communication channel, utilizing the communication system 203 and the signal combiner 206, to detect the presence of a Power Data Interface 207 (PDI). If a PDI 207 is present the computer system 201 determines the charging requirement of the battery 205 (or batteries), such as by comparing to the minimum and maximum previously discussed. If the battery 205 requires a charge the computer system 201 creates a Vehicle Charge Request Data Packet 1001 and forwards it to the PDI 207, via the communication channel, using standard power line communication techniques. If needed, it then awaits charging activity to start. During the recharge activity the VPBCS FIG. 2 monitors the power consumed by the VPBCS FIG. 2 with a digital power meter 204. The computer system 201 records the power consumed for comparison with the power consumption reported by the PDI 207 at the conclusion of the power charging activity. Once the battery 205 is re-charged to an appropriate level, such as being determined by comparing to the maximum previously discussed, the computer system 201 stops the charging activity and notifies the PDI 207 via the communication channel by sending a charge complete packet 1001. The charge complete packet 1001 indicates that charging is complete. When the charging activity is complete the computer system 201 records the information provided by a packet from the PDI 207 in the form of the a vehicle charge completion packet 1008 along with the power consumed as measured by the power meter 204. The computer system 201 then returns to monitoring the battery 205 and the power plug connection port. If the computer system 201 determines that no charge is required when a power cable 208 is plugged in the computer system 201 remains monitoring the battery 205 without communicating with the PDI 207. The operation of the VPBCS is further depicted in the flowchart in FIG. 13.

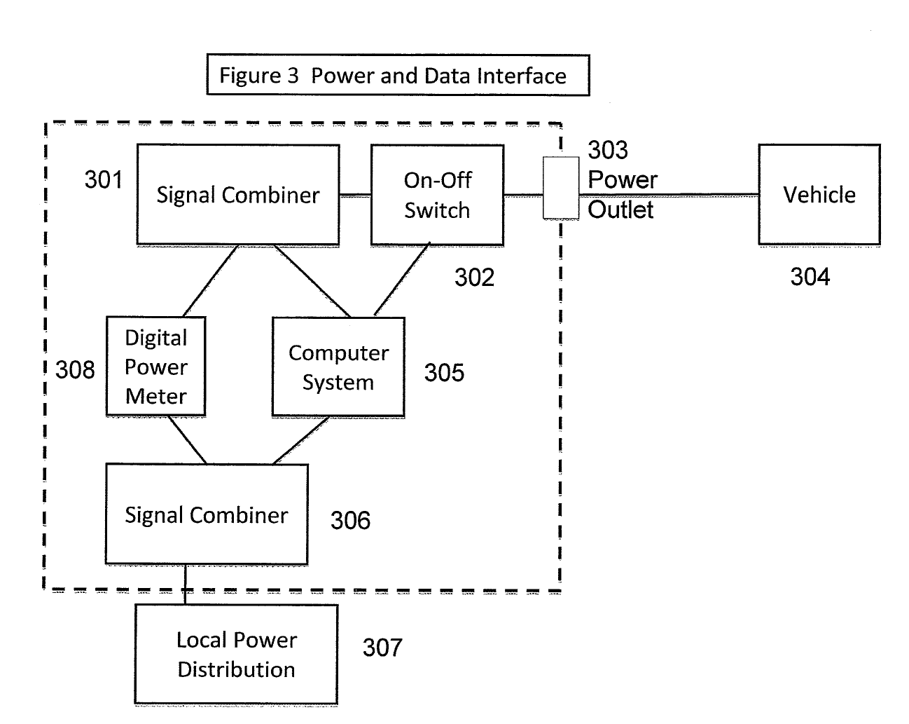

The Power Data Interface 102, FIG. 3, can include two Signal Combiners 301 and 306, On-Off Switch 302, digital power meter 304 and a computer system 305. The On-Off Switch 302 connects and disconnects the Utility power at the Power Outlet 303. The On-Off Switch 302 is controlled by the Computer System 305 to, for example, switch off power when the vehicle is charge I complete so that the plug is not “hot”. The Signal Combiners 301 and 306 provide the power line signal interfaces to the Computer System 305 to allow it to communicate with the Vehicle Power and Battery Charger 101 and the Local Power Control System (LPCS) 103. The Computer System 305 can communicate with the Vehicle Power and Battery Charger 101 via the power cable 208 connecting the vehicle to the PDI 207 utilizing power line signals. The Computer System 305 communicates with the Local Power Control System (LPCS) 208 via the Local Power Distribution 307 cabling utilizing power line signals (or other communication medium). The Computer System 305 contains memory that contains the instruction software to communicate with the Vehicle Power and Battery Charger, VPBC 101 and LPCS 103. The Computer System 305 handles the data packets 1001, 1002 to and from the vehicle VPBC 101. The Computer System 305 also handles the data packets 1003, 1004 to and from the LPCS 101. The data packets are shown in FIG. 10. The Digital Power Meter 304 measures the power consumed by the vehicle at the outlet 303.

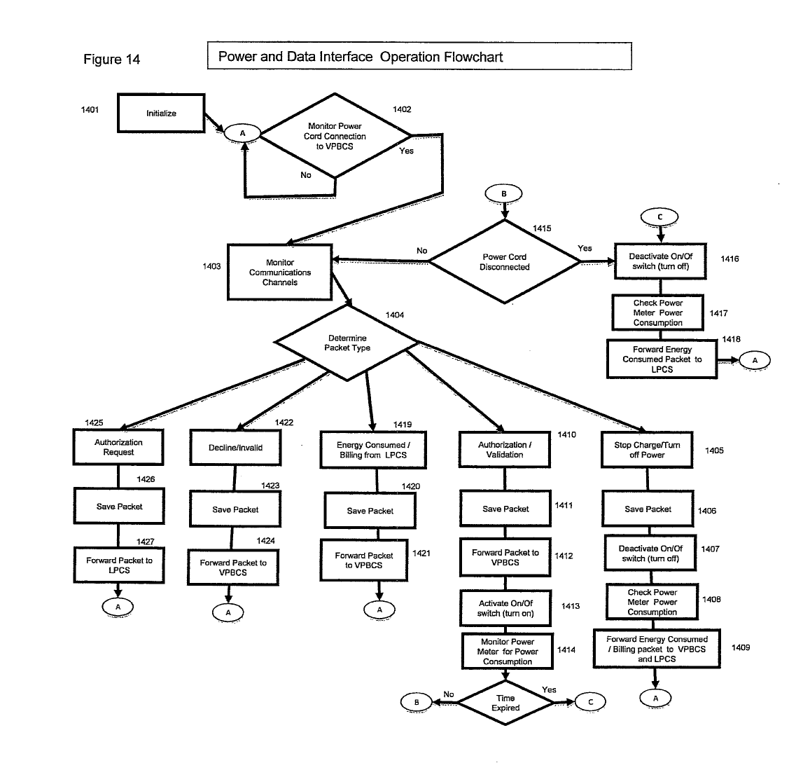

Once the PDI 207, FIG. 3, is initialized it performs the following functions. The computer system 305 constantly sends an alert signal to the electrical contacts of the power outlet 303. The signal is transmitted from the computer system 305 to the power outlet 303 via a signal combiner 301 using standard power line communication techniques. The signal is transmitted to a Vehicle Power Battery Charge (VPBCS) system, FIG. 2, using standard power line communication techniques via a power cord 208. When a power cord 208 is connected to both the power outlet 303 and the VPBC FIG. 2 (vehicle 304) the VPBC FIG. 2 has the option of communicating with the PDI FIG. 3 to request power be supplied to charge the vehicle battery 205. If the vehicle 304 needs its battery charged, the VPBCS sends a data packet 1001 to the computer system 305 via the power cable 208 and signal combiner 301. The computer system 305 stores the packet 1001 in its memory and transmits the packet 1003 to the Local Power Control System (LPCS) 307 via a signal combiner 308 using standard power line communication techniques. The computer system 305 waits for a data packet 1004 from the LPCS 307 which indicates if the transaction is allowed or denied. If the transaction is denied the received packet 1004 is forwarded to the vehicle 304 by the computer system 305 and the interaction with the vehicle is complete. If the transaction is allowed the computer system 305 activates the On-Off switch 302 to allow power to be supplied to the vehicle 304. While power is supplied to the vehicle, the computer system 305 monitors the communication channels between it and both the vehicle 305 and the LPCS 307 as well as the presence of the power cable 208 connection to the vehicle 304. The computer system 305 also uses the Digital Power Meter 308 to monitor the power consumed by the vehicle 304. The computer system 305 stores the power consumption in its memory until a transaction packet 1007 is generated at the completion of a transaction. The computer will allow power to be supplied to the vehicle 304 until either the vehicle sends a packet 1001 to turn off the power or the LPCS sends a packet 1004 to turn off the power or a pre-defined time limit is reached after which the power is turned off, the power cable 208 is disconnected, etc. Once the power is turned off for any reason the PDI, FIG. 3, computer system 305 generates a packet 1007 to notify the LPCS 307 of the amount of power consumed by the vehicle 304. Another packet 1008 is generated to send to the vehicle 304 if it is still connected to the power outlet 303. The operation of the PDI is further described in the flowchart in FIG. 14.

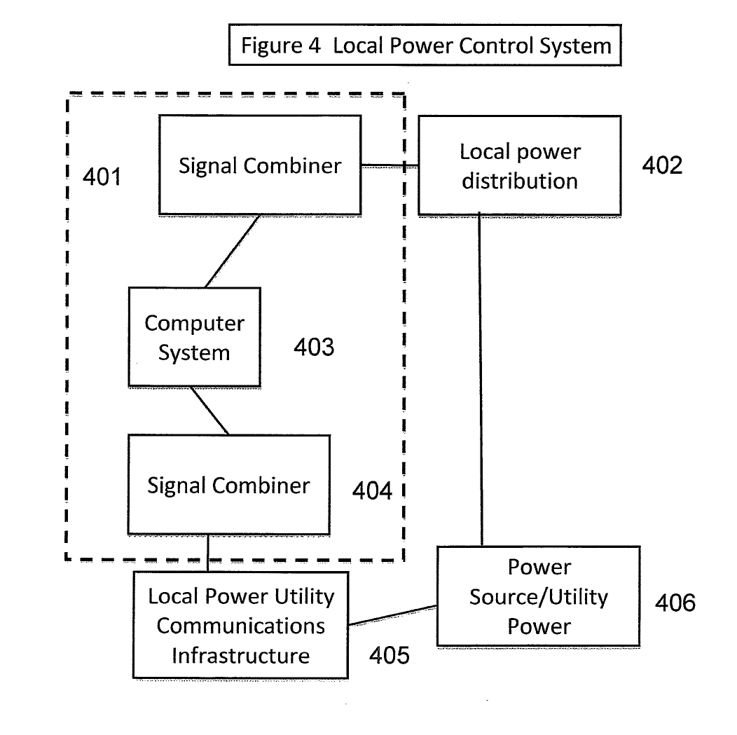

The Local Power Control System 103, see FIG. 4, can include two Signal Combiners 401 and 404 and a computer system 403. The Signal Combiners 401 and 404 provide the power line signal interfaces to the Computer System 403 to allow communication with the LPCS 103 and the Central Control System (CCS) 104. As noted previously, such communication can also be via other techniques, such as wire line, optical or wireless, as appropriate. The Computer System 403 communicates with the PDI 102 via the Local Power Distribution cabling 402 (or other communication medium). A single LPCS 103 may communicate with and control many PDIs (102). The Computer System 403 communicates with the CCS 104 utilizing the Local Power Utility Communication Infrastructure 405, such as power line communication, wired or optical communication lines, etc. The Computer System 403 contains memory that contains the instruction software to communicate with the PDI 102 and CCS 104 and contains the transaction information for both in-process and completed transactions. The Computer System 403, for example, handles data packets 1003, 1004 to and from the PDI 102 and records transactions with the vehicles. The Computer System 305 also handles data packets 1005, 1006 to and from the CCS 104. The data packets are described in FIG. 10.

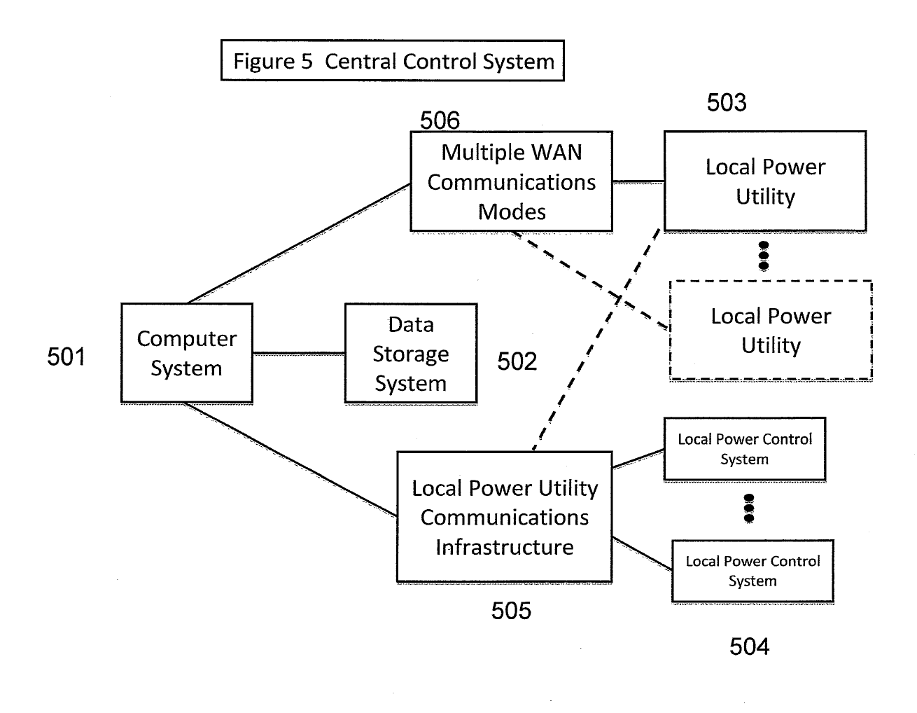

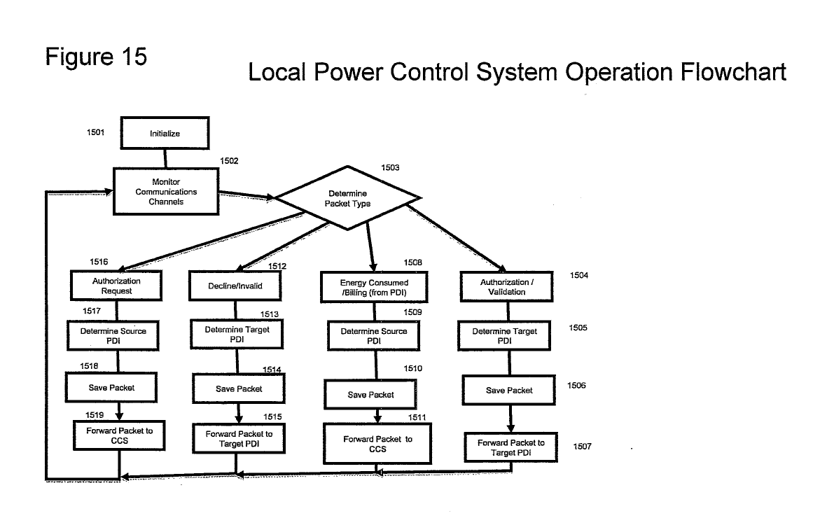

Once the Local Power Control System, FIG. 4, is initialized it performs the following functions. The LPCS, FIG. 4, computer system 403 maintains a table 1101 of information, in memory, of the transactions that occur at each of the PDIs, FIG. 3, that are associated with the individual LPCS FIG. 4. The computer system 403 records each completed and in process transaction in the table 1101. The table 1101 is shown in FIG. 11. The records may include (and not limited to): transactions, vehicle ID, charges, cost, etc. The LPCS FIG. 4 computer system 403 also processes requests for power (transaction requests) 1003 from the PDIs, FIG. 3. The computer system 403 records the transaction requests 1003 in its table 1101 and forwards the requests to the Central Control System (CCS), FIG. 5. The computer system 403 communicates with the PDIs, FIG. 3, and a single CCS, FIG. 5, using the signal combiners 401 and 403 with standard power line communication techniques. In addition the LPCS FIG. 4 computer system 403 receives transaction packets 1207 from the CCS. The computer system 403 records the transaction validation/approval packets 1207 in its data table 1101. The computer system 403 forwards the packet to the PDI 103 after recording the packet in its data table 1101. See FIG. 15 for a flowchart describing the operation of the LPCS.

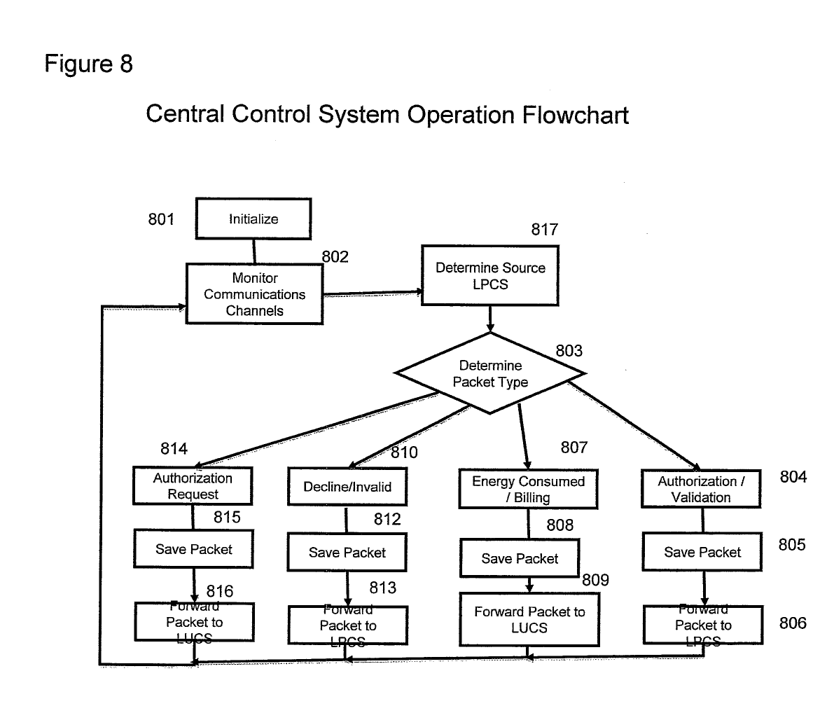

The Central Control System 104, see FIG. 5, can include a computer system 501 and a Data Storage System 502. The Computer System 501 communicates with multiple LPCSs 504 via the Local Power Utility Communication Infrastructure 505 or other communication mode, such as the Internet. The Computer System 501 communicates with the Local Power Utilities 503 via any one of multiple WAN communication modes 506 such as the Internet, private lines or frame relay, including the Local Power Utility Communication Infrastructure 505. An alternative embodiment would include the Computer System 501 communicating with multiple Local Utilities 503. The Data Storage System 502 stores the transactions generated and the instruction software for the Computer System 501 to process the transactions as described. The Computer System 501 utilizes the Data Storage System 502 to store the transactions as well as the information for unfinished transactions in process. The Computer System 501 processes data packets 1005, 1006 to and from the LPCSs 103. The Computer System 501 receives packets 1005 from the LPCSs 103, stores the information in each packet and forwards an authorization request packet 1009 to the Local Power Utility 503. The Computer System 501 receives acknowledgement packets 1010 both positive and negative from the Local Power Utility 503. A positive acknowledgement indicates the Local Power Utility 503 has approved the request for the vehicle to charge its battery. A negative acknowledgement indicates the Local Power Utility 503 has denied the request for the vehicle to charge its battery. If a positive acknowledgement is received from the Utility 503, the Computer System 501 sends a positive acknowledgement 1006 to the proper LPCS 504. If a negative acknowledgement is received from the Utility 503, the Computer System 501 can send a negative acknowledgement 1006 to the proper LPCS 504. The data packets are described in FIG. 10. See FIG. 8 for a flowchart describing the operation of the CCS.

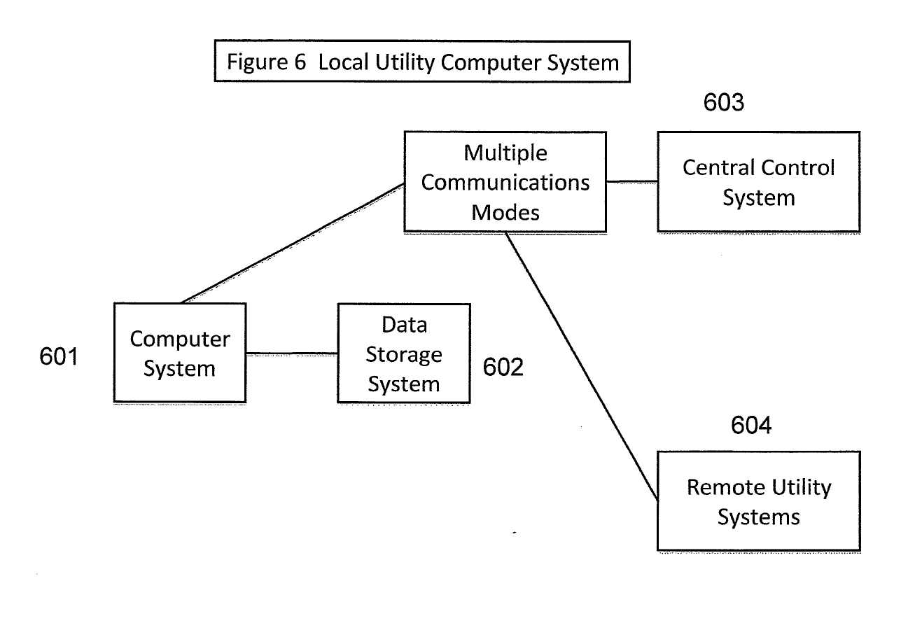

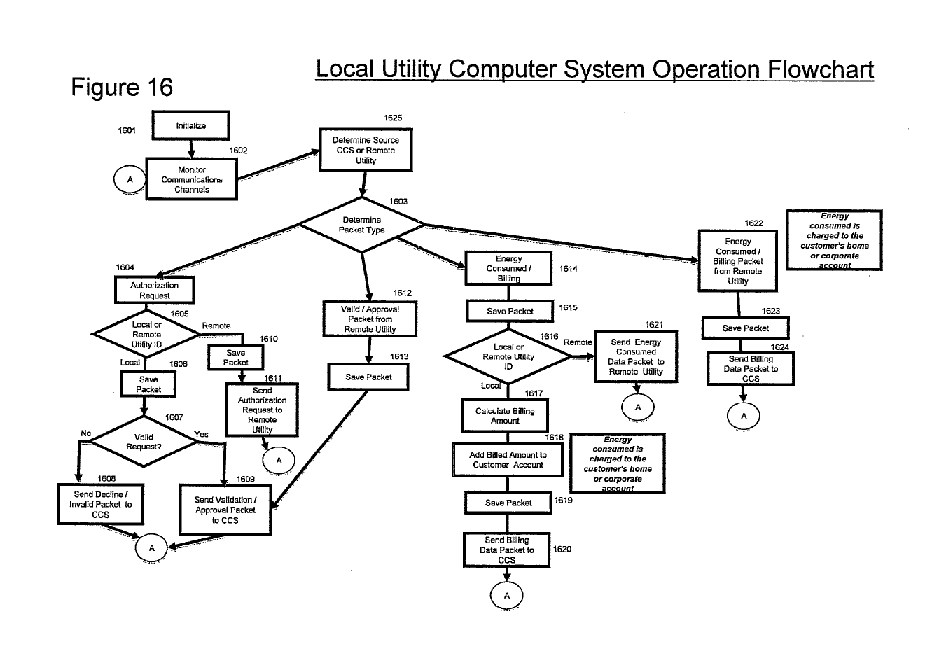

The Local Utility Computer System LUCS, FIG. 6, authorizes and declines vehicle charging requests. The LUCS computer system 601 also maintains a database of all transactions, both completed and in-process in table 1107 in the data storage system 602. In addition the LUCS processes the billing information, the charges for each transaction that are completed, in the home or company utility bill of the vehicle owner or operator. Once the LUCS computer 601 is initiated it monitors the multiple communication connections for communication from the Central Control Systems 603 and other Utility Systems 604. The computer system 601 communicates with the CCSs 603 to authorize or decline vehicle charging requests. The computer system 601 validates transaction requests 1206 by comparing the owner ID to the database of authorized account holders. If the owner ID is found to be valid the computer system 601 responds by sending an authorization packet 1207. If the owner ID is not found to be valid the computer system 601 responds by sending a declined/invalid packet 1210. If the Home Utility ID does not match the LUCS computer system utility ID the computer system 601 sends an authorization and validation request 1206 to the appropriate remote utility 604 for authorization. If the remote utility 604 authorizes the transaction with a validation/approval packet 1209, the computer system 601 responds to the appropriate central control system 603 with a validation/approval packet 1207. If the remote utility 604 declines the transaction with a denied/invalid packet 1213, the computer system 601 responds to the appropriate central control system 603 with a denied/invalid packet 1210. See FIG. 16 for a flow chart of the operation of the local utility computer system.

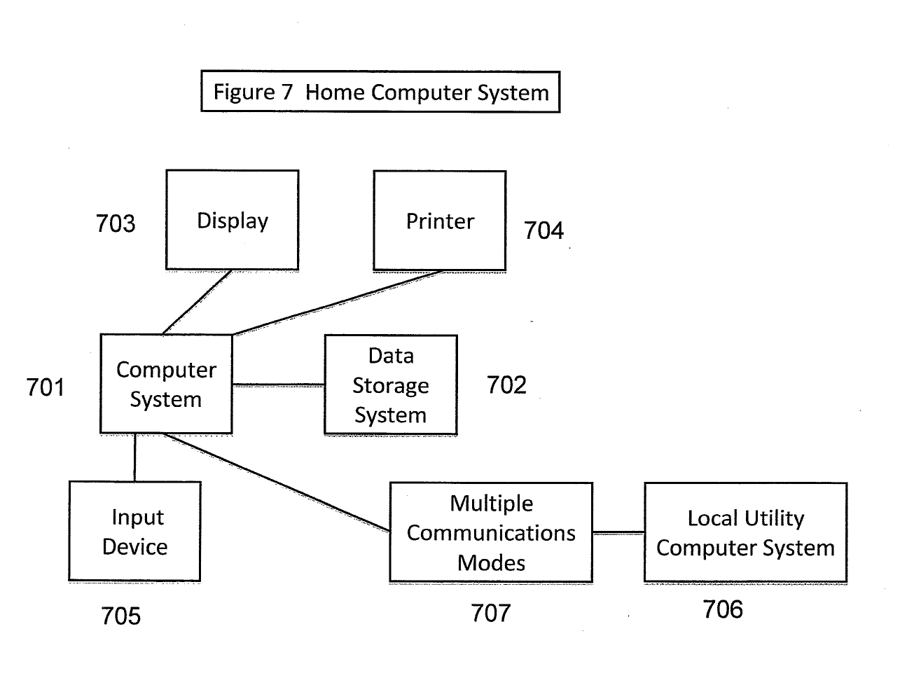

The Home Computer System (HCS) FIG. 7 is used by the vehicle owner or operator to track the vehicle charges. The computer system 701 receives the billing/charges from the local utility computer system 706 via any one of multiple types of communication modes (Internet, dial-in access, etc) 707. Once the billing/charges information is received the computer operator uses an input device (mouse or keyboard) 705 to view the information on the display 703 or printer 704. The computer operator has the option to save the information in the computer data storage system 702.

The following components, LPCS 103, CCS 104 and Utility 105 each store data during and after a transaction has occurred. The data storage table descriptions for these components are described in FIG. 11. The LPCS 103 stores the data necessary to track the PDIs 102 that are assigned and managed by the LPCS 103. The LPCS 103 also stores information describing the type of payment systems that are in use at the facilities for which the LPCS 103 operates 1102, such as credit card or Personal Identification Number (PIN) codes. The LPCS 103 also stores the data necessary to track the transactions taking place among all of the PDIs 102 under control of the LPCS 103. The CCS 104 data tables 1104, 1105 contain the LPCS 103 information and transaction information. CCS 104 Data Table 1104 contains the transaction information for each transaction. This table is used to record the transactions processed. CCS 104 Data Table 1105 contains the information to identify the PDIs 102. The Local Power Utility 105 table 1106 contains the customer information that can link each vehicle with the Utility 105 home or corporate billing account number. The Local Power Utility 105 table 1107 contains the transaction information for transactions that are in-process and completed.

The data packets depicted in FIG. 10 include a Vehicle Charge Request Data Packet 1001 that includes fields for the vehicle ID, owner ID, vehicle type code, time stamp and request type, such as approval request or charge finished notification. The Packet 1002 includes a field to indicate whether the charge request is approved or denied. The Packet 1003 includes the PDI ID. The Packet 1004 also includes an approval denial field. Packets 1005 and 1006 include a location field indicating the facility interacting with an identified vehicle. The Packet 1007 includes a field for indicating that a charge is complete and the amount of energy consumed to charge the vehicle battery. Packet 1008 has an acknowledgement field, a power consumed field and an amount of money charged or the cost of the charge. Packet 1009 also includes the request type. Packet 1010 includes an acknowledgment code. The packets can include other types of data, such as time and date stamps.

FIG. 11 shows the data tables used by the various components of the system. The PDI does not utilize a data table. It does not store multiple transactions. The PDI in an alternative embodiment may include a data table if that embodiment includes a PDI with the ability to charge multiple vehicles simultaneously. The LPCS table 1101 stores charging start and stop times, the vehicle and owner IDs, the vehicle type code, the location code for the parking space of the vehicle being interacted with, the location ID for the parking facility, the charge or energy consumed, the home utility ID for the vehicle/owner and the sent and received time stamps. The LPCS table 1102 includes the cost of each unit, such as kWh, the location ID for the LPCS and indicates the type of payment, local or central. The table 1103 also includes the power consumed by the vehicle connected to the PDI and the PDI location ID. The CCS table 1104 also includes start and stop times, the IDs and vehicle type, the parking space ID and LPCS ID, the power consumed, the home utility identifier ID and sent and received time stamps. The CCS table 1105 includes the LPCS ID, the pay type and the cost of each unit of consumption. Table 1106 is used by the local utility to store the customer ID, vehicle ID and home account number. Table 1107 is also used by the local utility and, in addition, to the customer and vehicle IDs, stores a transaction ID, an indicator as to whether the customer is local or of a remote utility, the local energy cost, remote energy cost, power consumed and the charge for the power consumed. Table 1108 identifies the remote utility, name and communication network ID. The tables can also include other information, such as average power consumption and other trend information for each owner and car.

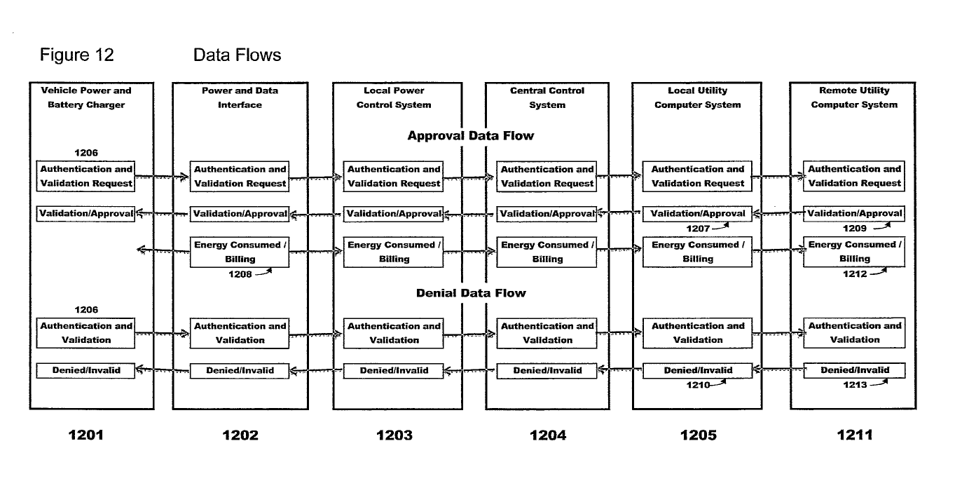

The data flows are described in FIG. 12.

Authentication and Validation Request: Request Packet

The Vehicle Power and Battery Charger (VPBC) 1201 initiates the transaction data via an Authentication and Validation request packet Request Packet 1206. The VPBC 1201 sends the Request Packet 1206 to the Power and Data Interface 1202. The Request Packet 1206 can take several forms as it proceeds upstream, such as 1001, 1003 and 1005 (see FIG. 10). The VPBC 1201 saves the Request Packet 1206 in non-volatile memory until the transaction is completed or charging ended. The Power and Data Interface (PDI) 1202 receives the Request Packet 1206 and passes the Request Packet 1206 to the LPCS 1203. The PDI 1202 also saves the Request Packet 1206 in non-volatile memory until the transaction is completed or charging ended. The LPCS 1203 receives the Request Packet 1206 and passes the Request Packet 1206 to the Central Control System (CCS) 1204. The LPCS 1203 saves the Request Packet 1206 in non-volatile memory until the transaction is completed or charging ended. The LPCS 1203 saves the Request Packet 1206 in the LPCS Data Table 1101. The CCS 1204 receives the Request Packet 1206 and passes the Request Packet 1206 to the Local Utility Computer System (LUCS) 1205. The CCS 1204 saves the Request Packet 1206 in the CCS Data Table 1104. The CCS 1204 maintains a database of all of the transactions in non-volatile memory. The LUCS 1205 receives the Request Packet 1206 and saves the Request Packet 1206 in the LUCS Data Table 1107. The LUCS 1205 maintains a database of all of the transaction data in non-volatile memory. The LUCS 1205 sends a Request Packet 1206 to a Remote Utility Computer System (RUCS) 1211 when required, when the vehicle owner is registered with a non-local utility company.

Validation/Approval Packet (VAP):

If the vehicle owner is registered with a non-local utility, a remote utility VAP 1209 is generated by the Remote Utility Computer System 1211 and sent to the LUCS 1205. The VAP can take several forms as it proceeds downstream including 1006, 1004 and 1002 see FIG. 10. The LUCS 1205 receives the VAP 1209 and saves the VAP 1209 in the LUCS Data Table 1107. The LUCS 1205 maintains a database of all of the transaction data in non-volatile memory. The LUCS 1205 generates a validation/approval packet 1207 after a Request Packet 1206 or a remote utility VAP 1209. The VAP 1207 is sent to the CCS 1204. The Central Computer System (CCS) 1204 receives the VAP 1207 and saves the VAP 1207 in the CCS Data Table 1104. The CCS 1204 maintains a database of all of the transaction data in non-volatile memory. The CCS 1204 passes the VAP 1207 to the Local Power Control System (LPCS) 1203. The LPCS 1203 receives the VAP 1207 and saves the VAP 1207 in the LPCS Data Table 1101. The LPCS 1203 saves the VAP 1207 in non-volatile memory until the transaction is completed.

The LPCS 1203 passes the VAP 1207 to the Power Data Interface (PDI) 1202. The PDI 1202 saves the VAP 1207 in non-volatile memory until the transaction is completed. The PDI 1202 passes the VAP 1207 to the Vehicle Power and Battery Charger (VPBC) 1201. The VPBC 1201 receives the VAP 1207 and saves it in non-volatile memory.

Energy Consumed/Billing Packet (ECBP):

The ECBP 1208 packet is generated by the PDI 1202. The ECBP packet can take various forms as needed as it proceeds upstream and downstream including 1007, 1008, 1009 and 1010 (see FIG. 10). The ECBP 1208 is passed simultaneously to the VPBC 1201 and the Local Power Control System (LPCS) 1203) by the PDI. Both devices receive the packet and save it in non-volatile memory. The LPCS 1203 saves the ECBP 1208 in the LPCS data table 1101. The LPCS 1203 passes the ECBP 1208 to the Central Control System (CCS) 1204. The CCS 1204 saves the ECBP 1208 in the CCS data table 1104. The CCS 1204 passes the ECBP 1208 to the Local Utility Computer System (LUCS) 1205. The LUCS 1205 saves the ECBP 1208 in the LUCS data table 1107. If the vehicle is registered with a Remote Utility, the LUCS 1205 will pass a remote ECBP 1212 to the Remote Utility Computer System (RUCS) 1211.

Denial/Invalid Packet (DIP)

If a denial is required because the owner is not registered or the information in an Authentication/Validation Request packet 1206 is corrupted/invalid a transaction denial packet (DIP) 1210 is generated by the Local Utility Computer System (LUCS) 1205. The DIP 1210 can take a number of forms as it proceeds downstream, including 1006, 1004 and 1002 (see FIG. 10). The DIP 1210 is passed to the Central Control System CCS 1204. The CCS 1204 saves the DIP 1210 in non-volatile memory. The CCS 1204 passes the DIP 1210 to the Local Power Control System (LPCS) 1203. The LPCS 1203 saves the DIP 1210 in non-volatile memory. The LCPS 1203 passes the DIP 1210 to the Power Data Interface (PDI) 1202. The PDI 1202 passes the DIP 1210 to the Vehicle Power and Battery Charger (VPBC) 1201. The VPBC 1201 saves the DIP 1210 in non-volatile memory.

If the vehicle owner is registered with a Remote Utility, the Remote Utility Power System will generate a Denial/Invalid Packet (DIP) 1213 in response to an invalid/corrupted authentication request 1206. In this situation a Transaction Denial Packet (TDP) 1213 will be sent to the Local Utility Computer System 1205 to indicate the vehicle is not authorized to consume power to be charged to the remote utility company.

As depicted in FIG. 13, the vehicle power and battery charger system (VPBCS), once initialized, 1301, begins monitoring 1302 the battery charge level and the power charging cable connection. When the cable is connected, 1303, the battery level is checked 1304. If the battery does not need to be recharged 1305, the operation returns to monitoring 1302. If a recharge is needed, a charge authorization packet is created 1306 and saved 1306. This packet is then forwarded 1308 to the power and data interface (PDI) 102 and the communication channel is monitored 1309 for a reply. When a reply is received 1301, it is checked 1311 to determine whether it is an authorization. If so, the packet is saved 1312, and charging starts 1313. The battery is then monitored 1314 and charging stopping is performed when the target level is reached 1315. When the appropriate level has been reached, a charge completion packet is prepared and sent 1316 to the PDI 102. The channel is then monitored 1317 for the packet that indicates the amount of energy consumed and the billing amount, which is stored and can be displayed on the vehicle display.

As depicted in FIG. 14, the power and data interface (PDI) 102, after initialization 1401, monitors 1402 the power connector to determine when a power cable is connected. When a connection is detected, the communication channels (both to the vehicle 101 and the local power control system 103, are monitored 1403. When a packet is received, the type is determined 1404. A charge stop packet 1405 is saved 1406 and the switch 302 is turned off 1407. The power consumption as indicated by the meter is read 1405 and sent 1409 to the LPCS 103. When an authorization packet is received 1401, the packet is saved 1411, forwarded 1412 to the vehicle and the switch 302 is turned on. Power consumption is them monitored. If time has not expired (the system can included a time-out timer to automatically de-activate the switch 302), the power cable is checked 1415 to see if it has been disconnected. If yes, the switch 320 is turned off 1416, the meter is checked 1417 and the energy consumed is sent 1418 in a data packet to the LPCS 103. When a packet indicating the energy consumed and the billing amount is received 1419, it is saved 1420 and forwarded 1421 to the vehicle 101. When a packet indicating that a request for charging is denied, is received 1422 from the LPCS 103, it is saved 1423 and sent 1424 to the vehicle 101. When a charge authorization request is received 1425 from the vehicle 101, it is saved and sent to the LPCS 103.

The local power control system (LPCS), as shown in FIG. 15, after being initialized 1501, monitors 1502 the communication channels with the PDIs 102 and the CCS 104. When a packet is received, the type is determined 1503. When an authorization packet is received 1504, the target PDI, that is the PDI that requested authorization, is determined 1505. The packet is saved 1506 and sent 1507 to the appropriate PDI. When packet is an energy consumption packet 1508, the source PDI is determined 1509 and the packet is saved 1510. The consumption packet is then sent to the CCS 104. When a decline packet is received 1512 from the CCS, the target PDI (the one requesting a charge authorization) is determined 1513, the packet is saved 1514 and sent 1515 to the appropriate PDI. When a change authorization packet is received 1516, the source PDI is determined, the packet is saved 1518 and sent 1519 to the CCS 104.

The central control system (CCS) 104 operation (see FIG. 8) starts with initialization 801 and proceeds to monitor 802 the communication channels to the LPCSs 103 and the local utility computer system (LUCS) 105. When a packet is received, the source is determined 817. Then the packet type is determined 803. When the packet is an authorization packet 804, the packet is saved 805 and sent 806 to the LPCS 103 that requested the authorization. When the packet is an energy consumption packet 807, this packet is saved 808 and sent 809 to the local utility (LUCS 105). When the packet is a decline packet 810, this packet is saved 812 and sent 813 to the LPCS 103. When the packet is an authorization request packet 814, it is saved 815 and sent 816 to the utility 105.

The local utility computer system 105, after it is initialized 1601 (see FIG. 16), monitors 1602 the communication channels with the CCSs 104 and remote utilities 604. The source of a packet is determined 1625 and the type of packet is determined 1603. When the packet is an authorization request 1604, a determination is made 1605 as to whether the utility for the customer is local or remote. When local, the packet is saved 1606 and a determination is made as to whether the request can be authorized/valid 1607 such as by checking to see if it is for a vehicle that is registered as a local electricity customer and participating in the program. If yes an approval or authorization packet is sent 1609 to the CCS making the request. If no, a decline packet is sent 1608. If the packet is an authorization request that needs to be validated by a remote utility, the packet is saved 1610 and sent 1611 to the remote utility. If the packet is an approval from a remote utility 1612, it is it saved and an approval is sent 1609. When the packet is an energy consumption packet 1614, it is saved 1615. When the energy consumed is determined 1616 to be for the local utility to bill, the billing amount is calculated 1617, added 1618 to the customers account, a charge amount packet is created and saved 1619 and sent to the appropriate CCS 104 (and then on to the vehicle 101). If the energy consumption packet is for a remote utility, it is sent 1621 to that utility. When the packet is a billing packet from a remote utility 1622, it is saved 1623 and sent 1624 to the appropriate CCS.

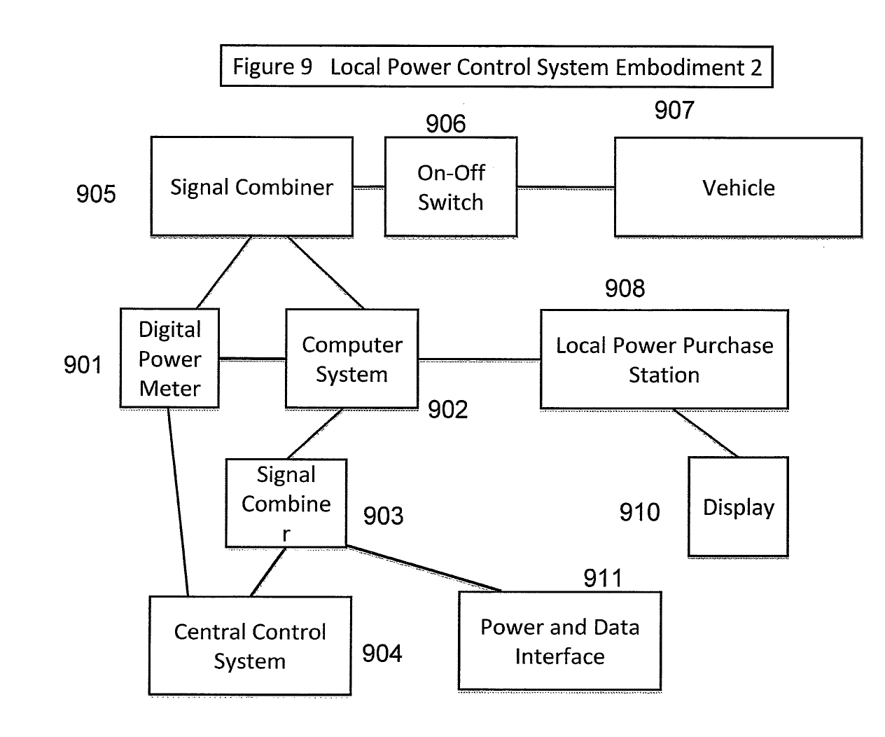

Another embodiment 2 of the Local Power Control System LPCS is depicted in FIG. 9. In this embodiment the vehicle owner or user is required to enter his identity at the parking area using a Local Power Purchase Station (LPPS) 908. The LPPS 908 has an alphanumeric keypad and display that is used to enter a personal identification number (PIN) and receive visual and audio feedback as part of the process to initiate a vehicle charge transaction. Once the user PIN is entered into the LPPS 908 the computer system 902 sends a charge request packet to the local utility 904 for approval. In this embodiment the LPCS can include the components of a previously described Power and Data Interface 102, FIG. 3, or communicate with multiple PDIs. In this embodiment the LPCS does both. If the vehicle 907 is connected directly to the LPCS On-Off switch 906 the LPCS may communicate with the vehicle 907, Vehicle Power and Battery Charge system 101 through the signal combiner 905. If the vehicle 907 is connected to a PDI 911 the LPCS communicates with the PDI 911, using the signal combiner 903.

Once the transaction packet has been generated by the computer system 902, the packet is sent to the Central Control System 904. The transaction is processed as previously described. If the transaction is denied the Local Power Purchase Station 908 notifies the user via audio and visual feedback. If the transaction is approved the LPCS turns the On-Off switch “on” to allow the vehicle to be charged and notifies the user via audio and visual feedback

The primary difference in this 2^{nd} embodiment is to allow users without VPBCS' 101, to charge their vehicle and have the cost of the energy consumed be charged to their home or corporate utility account.

The above description focuses on a system in which the vehicle includes the components that allow the charging to be billed on the vehicle owner's home utility bill. For those vehicles that do not have the vehicle system components discussed herein, a smart power cable can be a substitute. This smart cable would interface between the vehicle (plug) and the Power and Data Interface (PDI) 102 (plug). The smart cable can have a processor/computer that stores vehicle ID, owner ID, home utility ID, vehicle type code. The processor can be powered by the power being supplied by the PDI 102. When plugged into the PDI the cable processor can issue a request for a vehicle charge in much the same way as the VPBC 101 and interact with the PID/LPCS to allow the vehicle to be charged. A small limited character display could be provided to display the energy consumed (kWh) and the cost of the charge so the owner could see such when the vehicle is unplugged.

The above embodiments have described billing a vehicle owner's home utility account. However, the system can just as easily bill a company or corporate account. In such a situation, the system can email the particular vehicle user a message that indicates the power consumed, date, and other need information, so that the user can correlate use with a corporate fleet bill from the utility.

The embodiments can be implemented in computing hardware computing apparatus and/or software, such as in a non-limiting example any computer that can store, retrieve, process and/or output data and/or communicate with other computers. The results produced can be displayed on a display of the computing hardware. A program/software implementing the embodiments may be recorded on computer-readable media comprising computer-readable recording media. The computer readable media can be non-transitory. The program/software implementing the embodiments may also be transmitted over transmission communication media. Examples of the computer-readable recording media include a magnetic recording apparatus, an optical disk, a magneto-optical disk, and/or a semiconductor memory for example, RAM, ROM, etc. Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A method, comprising:
allowing a user to connect a vehicle to a charging station;
providing to the charging station, by the vehicle, vehicle charging identification information comprising a vehicle identification number, an owner identification code and a home power company identification;
determining a home power company identification using the charging identification information;
determining authorization for charging using the home power company identification by requesting authorization from the home power company using the charging identification information;
determining, by the vehicle, whether the vehicle needs to be charged;
starting charging the vehicle by the station upon authorization when the vehicle needs to be charged;
determining, by the station, power consumed during the charging;
determining, by the vehicle, when the vehicle is charged;
discontinuing charging by the station when the vehicle is charged;
determining a billing amount from the power consumed based on a charging station rate when the vehicle is charged;
entering the billing amount and the vehicle charging identification information into the home power company account of an owner of the vehicle owner;
communicating the rate, the billing amount and power consumed to the vehicle;
displaying the rate, the billing amount and power consumed in the vehicle when requested; and
communicating the rate, the billing amount, power consumed and the vehicle identification information to a computer of the owner of the vehicle using the vehicle identification information.

2. A method as recited in claim 1, wherein the home power company is a non-local power company.

3. A method as recited in claim 1, wherein the vehicle identification information is provided by a power cable.

4. A method as recited in claim 1, wherein the vehicle owner identity is entered by the vehicle user into the station.

5. A method, comprising:
charging an electric vehicle at a non-home location; and
billing the charging to vehicle owner home electric bill.

6. A. A system, comprising:
a vehicle charging system to charge an electric vehicle located at a non-home location; and
a system for billing the charge to a vehicle owner home electric bill.

7. A non-transitory storage media for controlling a computer with a data structure, the data structure comprising a vehicle field identifying a vehicle and a consumption field identifying an amount of an electric charge.

8. A non-transitory storage media for controlling a computer with a program, the program comprising operations of controlling charging an electric vehicle at a non-home location and facilitating billing the charging to vehicle owner home electric bill.

9. A display, comprising:
an indicator of power consumed in charging an electric vehicle; and
an indicator of a location of the charging.
